(19) United States
(12) Patent Application Publication
(10) Pub. No.: US 2025/0208409 A1
(43) Pub. Date: Jun. 26, 2025

(54) LENS MODULE AND CAMERA MODULE INCLUDING THE SAME

(71) Applicant: SAMSUNG ELECTRO-MECHANICS CO., LTD., Suwon-si (KR)

(72) Inventors: Seong Jin CHOI, Suwon-si (KR); Young Suk KANG, Suwon-si (KR); Won Hee KIM, Suwon-si (KR); Yong Joo JO, Suwon-si (KR)

(73) Assignee: SAMSUNG ELECTRO-MECHANICS CO., LTD., Suwon-si (KR)

(21) Appl. No.: 18/932,793

(22) Filed: Oct. 31, 2024

(30) Foreign Application Priority Data
Dec. 21, 2023 (KR) 10-2023-0188783

(51) Int. Cl. G02B 27/00; G02B 7/02

(52) U.S. Cl. CPC G02B 27/0018; G02B 7/026

(57) ABSTRACT

A lens module includes a lens barrel; a lens disposed in the lens barrel; and a press-fitting ring, disposed on an image side of the lens, including a protrusion disposed on a side surface. The side surface of the lens barrel has a first hole extending therethrough to expose at least a portion of the lens and a second hole formed by being recessed toward an object side from the first hole. The protrusion is disposed in the second hole.

### CROSS-REFERENCE TO RELATED APPLICATION(S)

This application claims the benefit under 35 USC 119(a) of Korean Patent Application No. 10-2023-0188783 filed on Dec. 21, 2023, in the Korean Intellectual Property Office, the entire disclosure of which is incorporated herein by reference for all purposes.

### BACKGROUND

### 1. Field

The present disclosure relates to a lens module and a camera module, including the same.

### 2. Description of the Background

A camera module may be composed of multiple lenses stacked along an optical axis inside a cylindrical barrel, and an optical filter and an image sensor are stacked at the bottom of the lens and a lens barrel inside the housing.

Additionally, conventional cameral modules may have a problem in that when strong light from a fluorescent light or a dark room is incident at a certain angle, the light at a certain angle may cause internal reflection on the lens rib surface accommodated in the lens barrel.

These light reflections are unrelated to image formation and are the cause of flares or ghosting on the screen.

A press-fitting ring may be used to secure a lens assembled in a lens barrel, and it may be desirable to prevent the press-fitting ring from rotating during the lens assembly and bonding process.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens module includes a lens barrel; a lens disposed in the lens barrel; and a press-fitting ring, disposed on an image side of the lens, including a protrusion disposed on a side surface. The side surface of the lens barrel has a first hole extending therethrough to expose at least a portion of the lens and a second hole formed by being recessed toward an object side from the first hole. The protrusion is disposed in the second hole.

A width of the second hole may be narrower than a width of the first hole.

The lens may include a major axis perpendicular to an optical axis and a minor axis perpendicular to both the optical axis and the major axis. A first side surface of the lens may extend along the major axis, and the first side surface may be disposed at a position corresponding to the side surface of the lens barrel.

The protrusion may include a first surface, a second surface spaced apart from the first surface in a direction perpendicular to the optical axis, and a third surface connecting the first surface and the second surface. The first surface and the third surface may be disposed vertically.

The protrusion may include a first surface, a second surface spaced apart from the first surface in a direction perpendicular to the optical axis, and a third surface connecting the first surface and the second surface. The second hole may include a 1-1 surface extending in a direction parallel to the optical axis, and the first surface may face the 1-1 surface.

The first surface and the 1-1 surface may be disposed parallel to each other.

The first surface and the 1-1 surface may be spaced apart in a direction perpendicular to the optical axis.

The first surface and the third surface may form an obtuse angle, and the 1-1 surface may be disposed to face the first surface.

The first surface and the 1-1 surface may be spaced apart in a direction perpendicular to the optical axis.

A distance between the first surface and the 1-1 surface may increase as distance increases in a direction away from the optical axis.

A camera module may include an image sensor, and the lens module described herein.

In another general aspect, a camera module includes an image sensor; and a lens module, including a lens barrel, a lens disposed in the lens barrel; and a press-fitting ring, disposed on an image side of the lens, including a protrusion disposed on a side surface. The side surface of the lens barrel has a first hole extending therethrough to expose at least a portion of the lens and a second hole formed by being recessed toward an object side from the first hole, and the protrusion is disposed in the second hole.

A portion of the lens may be exposed through the first hole when viewed from the side surface of the lens barrel.

The protrusion may include a first surface, a second surface spaced apart from the first surface in a direction perpendicular to an optical axis, and a third surface connecting the first surface and the second surface. The first surface and the third surface may be disposed vertically.

The protrusion may include a first surface, a second surface spaced apart from the first surface in a direction perpendicular to the optical axis, and a third surface connecting the first surface and the second surface. The second hole may include a 1-1 surface extending in a direction parallel to the optical axis, and the first surface may face the 1-1 surface.

The first surface and the third surface may form an obtuse angle, and the 1-1 surface may be disposed facing the first surface.

A distance between the first surface and the 1-1 surface may increase as a distance increases in a direction away from the optical axis.

Other features and aspects will be apparent from the following detailed description, the drawings, and the claims.

### BRIEF DESCRIPTION OF DRAWINGS

FIG. 1 is an assembled perspective view of a camera module according to an embodiment of the present disclosure.

FIG. 2 is an exploded perspective view of a camera module according to an embodiment of the present disclosure.

FIG. 3 is a perspective view of a lens module according to an embodiment of the present disclosure.

FIG. 4 is an exploded perspective view of a lens module according to an embodiment of the present disclosure.

FIG. 5 is an exploded perspective view of a lens module according to an embodiment of the present disclosure.

FIG. 6 is a side view of a lens module according to an embodiment of the present disclosure.

FIG. 7 is a side view of a lens barrel according to an embodiment of the present disclosure.

FIG. 8 is a plan view of a press-fit ring according to an embodiment of the present disclosure.

FIG. 9 is an enlarged view of a portion of a lens module according to an embodiment of the present disclosure.

FIGS. 10 and 11 are enlarged views of portions of lens modules according to further embodiments of the present disclosure.

FIG. 12 is a side view of a lens module according to another embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

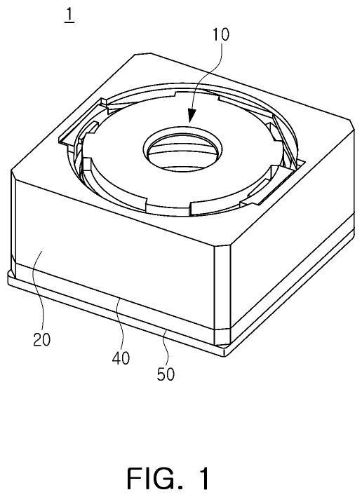

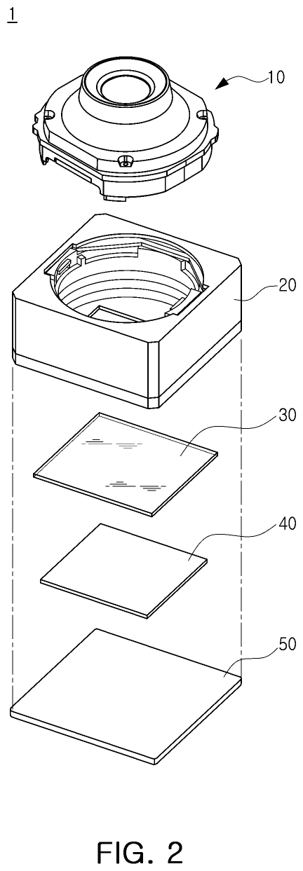

FIG. 1 is a perspective view of a camera module according to an embodiment of the present disclosure, and FIG. 2 is an exploded perspective view of a camera module according to an embodiment of the present disclosure.

Referring to FIGS. 1 and 2, a camera module 1, according to an embodiment of the present disclosure, includes at least a lens module 10, a housing 20, an optical filter 30, such as an infrared filter (IR filter), an image sensor 40, and a circuit board 50.

Here, a plurality of lenses are sequentially stacked from an object side to an image side inside a lens barrel 100, and the lens barrel 100 may disposed inside the housing 20.

The plurality of lenses may be fixed to the lens barrel 100 by press-fitting or bonding with adhesive. Alternatively, the plurality of lenses may be fixed by a press-fitting ring 300 supporting the lens which is disposed last in the image side direction.

Additionally, an optical filter 30 fixed to a housing 20 may be provided at the bottom of the lens barrel 100, and a circuit board 50 having an image sensor 40 attached to an imaging plane may be coupled to the bottom of the housing 20.

According to the above structure, light incident on the upper portion of the lens barrel 100 passes through the lenses, the optical filter 30, and is received by the image sensor 40, thereby capturing an image.

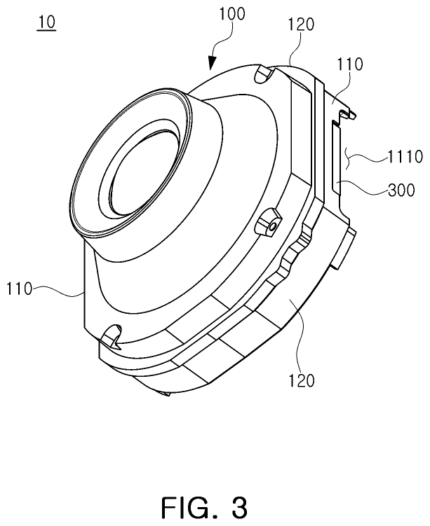

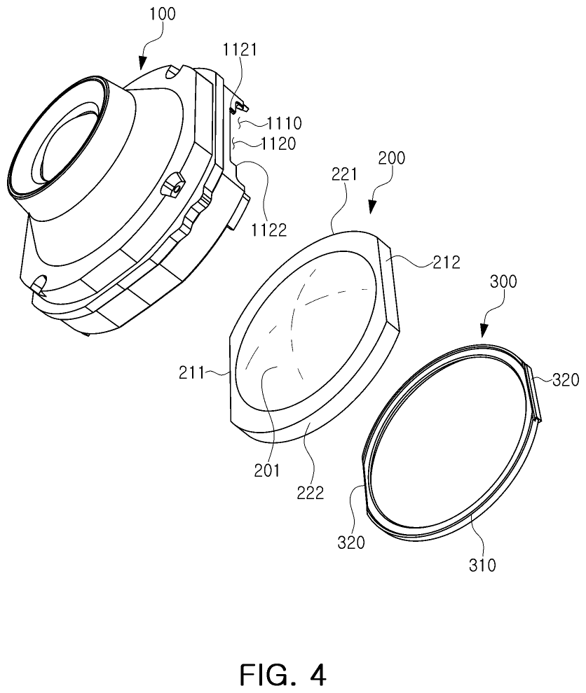

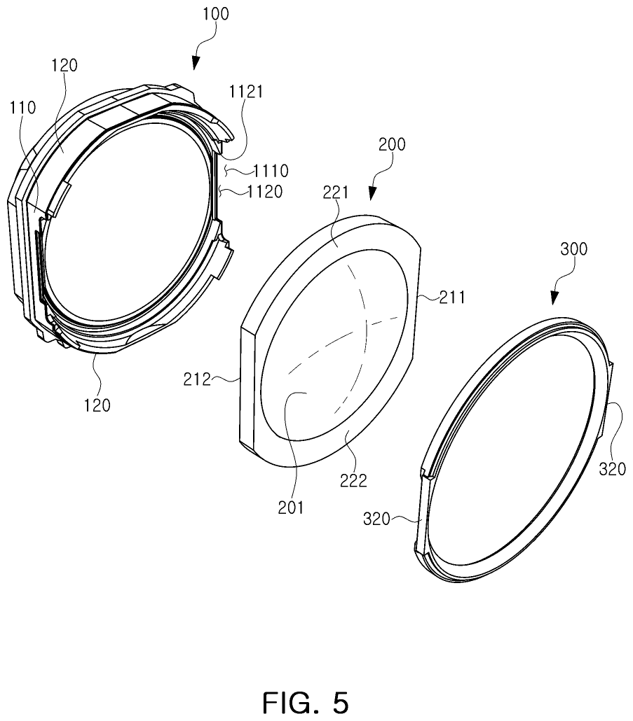

FIG. 3 is a perspective view of a lens module according to an embodiment of the present disclosure. FIG. 4 is an exploded perspective view of a lens module according to an embodiment of the present disclosure. FIG. 5 is another exploded perspective view of a lens module according to an embodiment of the present disclosure.

The lens barrel 100 may include a ‘D’-shaped D-cut portion 110 in which a portion of the outer surface is flatly cut at the lower portion, i.e., the image side (in the direction of the image sensor 40) of the lens barrel 100, and a rounded portion 120 forming a portion other than the D-cut portion 110 to maximize space utilization.

The lens barrel 100 may eliminate unnecessary space of the lens barrel 100 by including a D-cut portion 110, thereby enabling the miniaturization of the camera module 1. The D-cut portion 110 of the lens barrel 100 may be provided in at least one pair on both sides symmetrically centered on the optical axis.

A first lens 200 may be disposed at the rearmost portion of the lens barrel 100. The first lens 200 may be a D-cut lens with major and minor axes.

The first lens 200 may include a first side surface 211. The first side surface 211 may be a surface extending along the longitudinal axis of the first lens 200. The first side surface 211 may be disposed at a position corresponding to the D-cut portion 110 of the lens barrel 100.

The first lens 200 may include a second side surface 212. The second side surface 212 may be a surface extending along the longitudinal axis of the first lens 200. The second side surface 212 may be disposed parallel to the first side surface 211. The second side surface 212 may be disposed on the opposite side between the first side surface 211 and the optical axis.

The first lens 200 may include a third side surface 221. The third side surface 221 may be a flange portion extending from an effective surface of the first lens 200. The third side surface 221 may extend along a short axis direction of the first lens 200. The third side surface 221 may be disposed at a position corresponding to a rounded portion 120 of the lens barrel 100.

The first lens 200 may include a fourth side surface 222. The fourth side surface 222 may be a flange portion extending from an optical portion 201 of the first lens 200. The fourth side surface 222 may extend along the minor axis direction of the first lens 200. The fourth side surface 222 may be disposed at a position corresponding to the rounded portion 120 of the lens barrel 100.

The third side surface 221 and the fourth side surface 222 may be disposed parallel to each other. The third side surface 221 and the fourth side surface 222 may be disposed on opposite sides with the optical axis therebetween.

The press-fitting ring 300 may be combined with the lens barrel 100. The first lens 200 may be disposed on a front side of the press-fitting ring 300. The first lens 200 and the press-fitting ring 300 may be disposed sequentially in the lens barrel 100. The press-fitting ring 300 may press the first lens 200 against the lens barrel 100 from an image side to an object side.

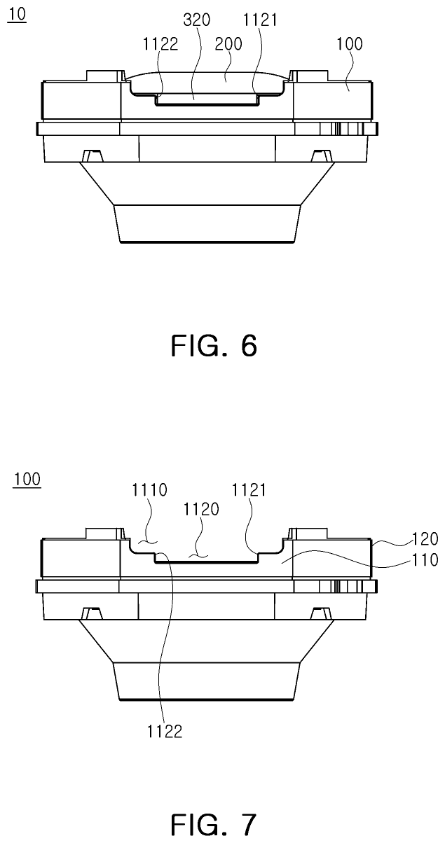

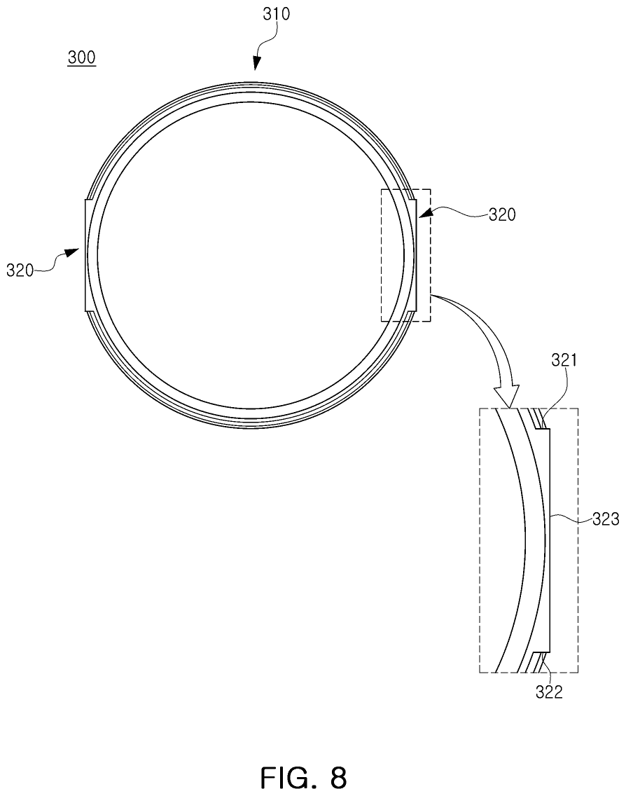

FIG. 6 is a side view of a lens module according to an embodiment of the present disclosure. FIG. 7 is a side view of a lens barrel according to an embodiment of the present disclosure.

The lens barrel 100 may include a surface from an image side with a first hole 1110 and a second hole 1120 therethrough. The first hole 1110 and the second hole 1120 may be disposed in the D-cut portion 110 of the lens barrel 100.

The first hole 1110 may be formed by recessing a portion of the side surface of the lens barrel 100 from an image side to an object side. When viewed from the side surface of the lens barrel 100, a portion of the first lens 200 may be exposed through the first hole 1110. Since the first hole 1110 exposes a portion of the side surface of the first lens 200, light reflected by the first hole 1110 may be emitted outside of the lens barrel 100. Therefore, light may be prevented from being diffusely reflected into the inside of the lens barrel 100.

The second hole 1120 may be a hole extending from the first hole 1110. The second hole 1120 may be formed by being recessed from the first hole 1110 toward the object side. The second hole 1120 may be formed by being recessed from a portion of the side surface of the lens barrel 100 from the image side toward the object side. The second hole 1120 may be disposed with a step from the first hole 1110. The second hole 1120 may be disposed closer to the object side than the first hole 1110. The width of the second hole 1120 based on the direction perpendicular to the optical axis may be smaller than the width of the first hole 1110 based on the direction perpendicular to the optical axis.

A part of the press-fitting ring 300 may be disposed in the second hole 1120. Specifically, a protrusion 320 of the press-fitting ring 300 may be disposed in the second hole 1120.

The second hole 1120 may include a 1-1 surface 1121 and a second-first surface 1122. The 1-1 surface 1121 may be a surface extending in a direction parallel to the optical axis. The 1-1 surface 1121 may be disposed to face the 2-1 surface. The 1-1 surface 1121 may be disposed on the opposite side of the 2-1 surface. The 1-1 surface 1121 may face the first surface 321 of the press-fitting ring 300, to be described later, and the 2-1 surface 1122 may face the second surface 322 of the press-fitting ring 300, to also be described later.

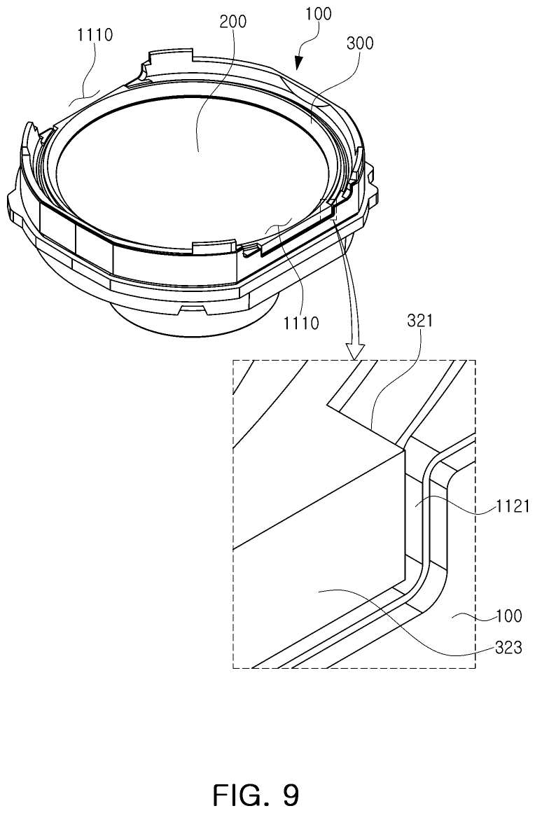

FIG. 8 is a plan view of a press-fitting ring according to an embodiment of the present disclosure.

The press-fitting ring 300 may include a body part 310 and a protrusion portion 320. The body part 310 may form the overall appearance of the press-fitting ring 300 in a ring shape. The protrusion portion 320 may be disposed on the side of the press-fitting ring 300. The protrusion portion 320 may have a structure that protrudes in a direction perpendicular to the optical axis from the body part 310.

The protrusion portion 320 may include a first surface 321, a second surface 322, and a third surface 323.

The first surface 321 may be a surface extending away from the optical axis in the body portion 310. The first surface 321 may face the 1-1 surface 1121 disposed on the lens barrel 100.

The second surface 322 may correspond to the first surface 321. The second surface 322 may be disposed on the opposite side of the first surface 321. The second surface 322 may be a surface extending away from the optical axis in the body portion 310. The second surface 322 may face the 2-1 surface 1122 disposed on the lens barrel 100.

The third surface 323 may extend from the first surface 321 and the second surface 322. The third surface 323 may be disposed in the second hole 1120. When viewed from the surface of the lens module 10, the third surface 323 may be exposed through the second hole 1120.

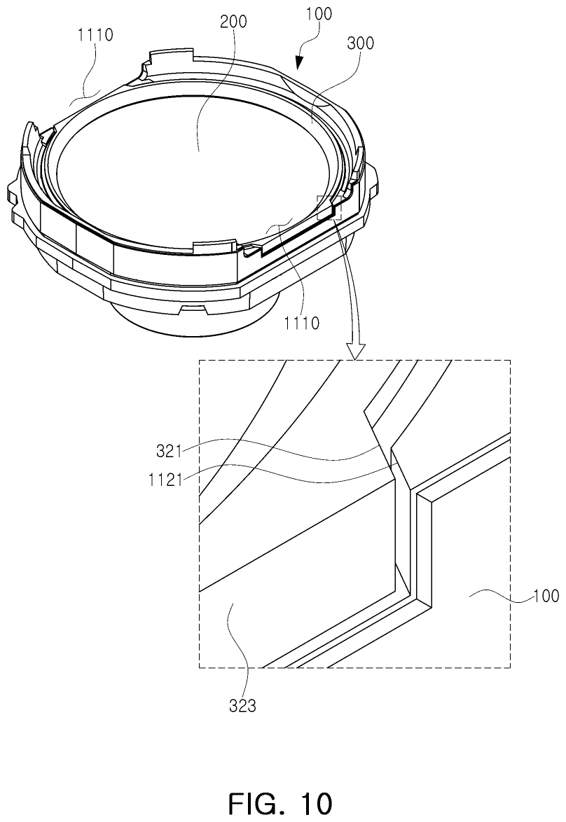

FIG. 9 is an enlarged view of a portion of a lens module according to an embodiment of the present disclosure.

Referring to FIG. 9, the first surface 321 of the press-fitting ring 300 may be disposed perpendicularly to the third surface 323 of the press-fitting ring 300. The first surface 321 may be disposed facing the 1-1 surface 1121 of the lens barrel 100. The first surface 321 and the 1-1 surface 1121 may be disposed parallel. At least a portion of the first surface 321 may overlap the 1-1 surface 1121 in a direction perpendicular to the optical axis. At least a portion of the first surface 321 may be disposed in the second hole 1120. When the press-fitting ring 300 coupled to the lens barrel 100 rotates, the first surface 321 may come into contact with the 1-1 surface 1121, and as the 1-1 surface 1121 supports the first surface 321, the rotation of the press-fitting ring 300 may be prevented.

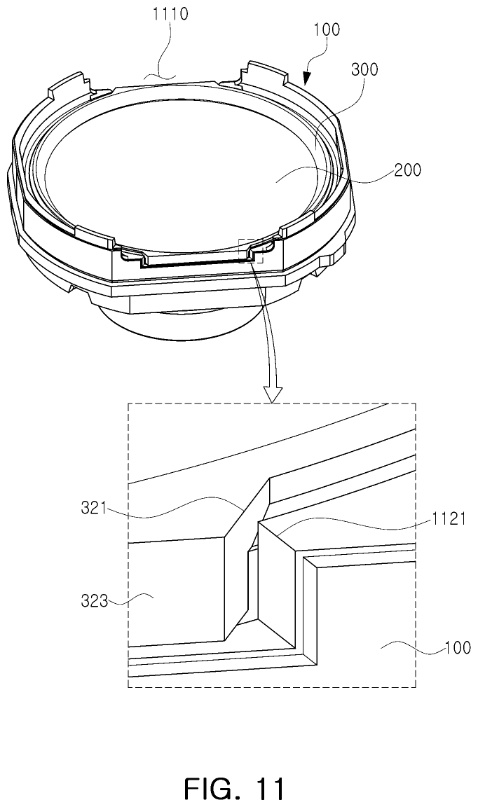

FIG. 10 is an enlarged view of a portion of a lens module according to another embodiment of the present disclosure.

Referring to FIG. 10, the first surface 321 of the press-fitting ring 300 may be a surface that may be disposed at an inclined angle. The first surface 321 and the third surface 323 may be disposed at an obtuse angle. The first surface 321 may be disposed facing the 1-1 surface 1121 of the lens barrel 100.

The 1-1 surface 1121 may be disposed at an inclined angle. That is, the 1-1 surface 1121 may include an inclined surface corresponding to the first surface 321 disposed at an inclined angle. Therefore, when the press-fitting ring 300 is to rotate around the optical axis, the first surface 321 and the 1-1 surface 1121 may come into surface contact with each other to prevent the rotation of the press-fitting ring 300.

FIG. 11 is an enlarged view of a portion of a lens module according to another embodiment of the present disclosure.

Referring to FIG. 11, the first surface 321 of the protrusion 320 may be a surface that may be disposed at an inclined angle with the third surface 323. The first surface 321 and the third surface 323 may be disposed at an obtuse angle. The first surface 321 may be disposed to overlap the 1-1 surface 1121 of the lens barrel in a direction perpendicular to the optical axis.

The 1-1 surface 1121 may be a surface that may be disposed at an inclined angle with the first surface 321. The inclination directions of the 1-1 surface 1121 and the first surface 321 may be opposite to each other. That is, the farther away from the optical axis, the greater the distance between the first surface 321 and the 1-1 surface 1121. That is, as the press-fitting ring 300 is to rotate around the optical axis, the first surface 321 and the 1-1 surface 1121 may come into linear contact with each other.

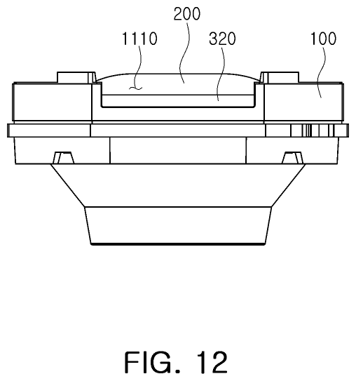

FIG. 12 is a side view of a lens module according to another embodiment of the present disclosure. Referring to FIG. 12, the lens barrel 100 may include a first hole 1110. The first hole 1110 may be formed by recessing a portion of a side surface of the lens barrel 100 from an object side to an image side. A protrusion 320 of a press-fitting ring 300 may be disposed in the first hole 1110. A protrusion 320 of a press-fitting ring 300 may be disposed in a portion of the first hole 1110, and a portion of the first lens 200 may be exposed through another portion of the first hole 1110.

The protrusion 320 of the press-fitting ring 300 may be disposed in the first hole 1110 to prevent rotation of the press-fitting ring 300.

As the lens barrel 100, according to the above description, includes a D-cut portion 110, when the lens barrel 100 may be viewed from an object side or an image side, it may have a minor axis and a major axis. That is, since the lens barrel 100 may have a D-cut portion 110, the size of the lens module 10 may be reduced, and accordingly, there may be an advantage in that the camera module 1 may be miniaturized.

One or more aspects of the present disclosure is to reduce flare and ghost phenomena, and improve the assembly stability of a lens module by applying a flare reduction structure and an anti-rotation structure of a press-fitting ring to the lens module.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens module comprising:
a lens barrel;
a lens disposed in the lens barrel; and
a press-fitting ring, disposed on an image side of the lens, comprising a protrusion disposed on a side surface,
wherein the side surface of the lens barrel has a first hole extending therethrough to expose at least a portion of the lens and a second hole formed by being recessed toward an object side from the first hole, and
wherein the protrusion is disposed in the second hole.

2. The lens module of claim 1, wherein a width of the second hole is narrower than a width of the first hole.

3. The lens module of claim 1, wherein the lens comprises a major axis perpendicular to an optical axis and a minor axis perpendicular to both the optical axis and the major axis,
wherein a first side surface of the lens extends along the major axis, and
wherein the first side surface is disposed at a position corresponding to the side surface of the lens barrel.

4. The lens module of claim 1, wherein the protrusion comprises a first surface, a second surface spaced apart from the first surface in a direction perpendicular to the optical axis, and a third surface connecting the first surface and the second surface, and
wherein the first surface and the third surface are disposed vertically.

5. The lens module of claim 1, wherein the protrusion comprises a first surface, a second surface spaced apart from the first surface in a direction perpendicular to the optical axis, and a third surface connecting the first surface and the second surface,
wherein the second hole comprises a 1-1 surface extending in a direction parallel to the optical axis, and
wherein the first surface faces the 1-1 surface.

6. The lens module of claim 5, wherein the first surface and the 1-1 surface are disposed parallel to each other.

7. The lens module of claim 5, wherein the first surface and the 1-1 surface are spaced apart in a direction perpendicular to the optical axis.

8. The lens module of claim 5, wherein the first surface and the third surface form an obtuse angle, and
wherein the 1-1 surface is disposed to face the first surface.

9. The lens module of claim 8, wherein the first surface and the 1-1 surface are spaced apart in a direction perpendicular to the optical axis.

10. The lens module of claim 8, wherein a distance between the first surface and the 1-1 surface increases as distance increases in a direction away from the optical axis.

11. A camera module, comprising:
an image sensor; and
the lens module of claim 1,
wherein a width of the second hole is narrower than a width of the first hole.

12. A camera module, comprising:
an image sensor; and
a lens module, comprising:
a lens barrel;
a lens disposed in the lens barrel; and
a press-fitting ring, disposed on an image side of the lens, comprising a protrusion disposed on a side surface,
wherein the side surface of the lens barrel has a first hole extending therethrough to expose at least a portion of the lens and a second hole formed by being recessed toward an object side from the first hole, and
wherein the protrusion is disposed in the second hole.

13. The camera module of claim 12, wherein a portion of the lens is exposed through the first hole when viewed from the side surface of the lens barrel.

14. The camera module of claim 12, wherein the protrusion comprises a first surface, a second surface spaced apart from the first surface in a direction perpendicular to an optical axis, and a third surface connecting the first surface and the second surface, and
wherein the first surface and the third surface are disposed vertically.

15. The camera module of claim 12, wherein the protrusion comprises a first surface, a second surface spaced apart from the first surface in a direction perpendicular to the optical axis, and a third surface connecting the first surface and the second surface,
wherein the second hole includes a 1-1 surface extending in a direction parallel to the optical axis, and
wherein the first surface faces the 1-1 surface.

16. The camera module of claim 15, wherein the first surface and the third surface form an obtuse angle, and
wherein the 1-1 surface is disposed facing the first surface.

17. The camera module of claim 15, wherein a distance between the first surface and the 1-1 surface increases as a distance increases in a direction away from the optical axis.
